(19) United States
(12) Patent Application Publication
(10) Pub. No.: US 2022/0356658 A1
(43) Pub. Date: Nov. 10, 2022

(54) SECURITY BARRIER LIGHT AND COMMUNICATION SYSTEM

(71) Applicant: JACOB CAVAL, Twin Falls, ID (US)

(72) Inventor: JACOB CAVAL, Twin Falls, ID (US)

(21) Appl. No.: 17/723,962

(22) Filed: Apr. 19, 2022

Related U.S. Application Data
(60) Provisional application No. 63/177,649, filed on Apr. 21, 2021.

(51) Int. Cl. E01F 13/02; G08B 25/10; G08B 7/06; G08B 13/196

(52) U.S. Cl. CPC E01F 13/022; G08B 25/10; G08B 7/06; G08B 13/19632; G08B 13/1966

(57) ABSTRACT

A system for restricting access to an area includes a security barrier with a security hood. The security hood includes a body having a plurality of openings, a plurality of lights positioned within the plurality of openings, a control module and a communications system. The lights may be recessed into the body. The control module changes the security hood between an inactive state and an active state. The control module controls the plurality of lights. The communications system receives data from a remote command location and provides the data to the control module. The data includes instructions for altering operation of the security hood. The communications system may include a satellite link.

### RELATED APPLICATION DATA

The present application claims the benefit of priority under 35 U.S.C. § 119 to U.S. Provisional Application No. 63/177,649, filed Apr. 21, 2021, entitled “Security Barrier Light And Communication System,” the disclosure of which is incorporated herein by reference in its entirety.

### FIELD OF THE DISCLOSURE

The embodiments described herein relate generally to apparatuses, methods, and systems for restricting access to an area by vehicle or other traffic. More particularly, the disclosure relates to a system that can be integral to a stationary security barrier or may be incorporated into a security hood that is received upon a top of a stationary security barrier.

### BACKGROUND

### Description of the Related Art

Security barriers are increasingly needed in light of the unpredictability of events around the world. For instance, security barriers may be installed along public areas such as sidewalks to stop vehicles from traveling into these areas and/or into buildings. Among the most common types of temporary barriers are jersey barriers, which can be positioned via a forklift or crane. Security barriers may be characterized as an active barrier, that opens and closes to allow access, or passive barriers that remain closed until removed and/or uninstalled. Examples of active barriers may include a wedge barrier that has a moveable angled metal plate positioned toward approaching vehicles, a beam barrier that swings or telescopes to restrict passage, bollards that are vertical cylinders capable of being retracted into the ground, and wheeled barriers.

In some instances, passive barriers may be ineffective at inhibiting access to unauthorized persons. For instance, it may be desirable to place passive barriers in front of buildings to inhibit access of vehicles but to still permit access to persons attempting to enter the building. However, a need may arise to temporarily restrict access to persons attempting to enter the building and additional steps must be taken such as erecting another barrier or positioning guards near the barrier. Other disadvantages of known security barriers may exist.

### SUMMARY

The present disclosure is directed to security barriers and methods of restricting access to areas that overcome some of the problems and disadvantages discussed above.

An embodiment of a system for restricting access to an area includes a security hood. The security hood includes a body having a plurality of openings, a plurality of lights positioned within the plurality of openings, a control module and a communications system. The control module is operable to change the security hood between an inactive state and an active state. The control module is operable to control the plurality of lights. The communications system is operable to receive data from a remote command location and provide the data to the control module. The data includes instructions for altering operation of the security hood. The communications system may include a satellite link.

The system may include a security barrier having a tower. The security hood may have a bottom shaped complementary to a top of the tower of the security barrier, and the security hood may be configured to attach to the tower. Alternatively, the security hood may be integral to the tower of the security barrier. The body may have a plurality of sides, including a front. At least one of the plurality of openings and at least one of the plurality of lights are positioned on the front. One or more of the plurality of lights may be recessed within the plurality of openings.

The body includes a top extending between the plurality of sides. The front may be sloped towards the top. The body may be formed of a steel having a thickness of at least 0.25 inches (6.35 mm).

The security hood may include a light bar oriented towards the front. The light bar may have a plurality of sections that can be illuminated independently of each other. The control module is configured to modify operation of the light bar. The light bar may be operable to change colors. The system may include a guard partially enclosing the light bar and covering at least a top of the light bar. The guard may slope away from the front of the security hood.

The system may include a speaker operable to broadcast audible warnings. The control module is configured to modify operation of the speaker. The system may include a display positioned on the front of the security hood. The display is operable to broadcast written messages. The control module is configured to modify operation of the display.

The system may include a camera and the communications system may be operable to transmit images taken by the camera to the remote command location. The images may be a video stream. The camera may be recessed within the front of the security hood. The camera may have a lens diameter of less than 10 millimeters.

The system may include one or more defense systems. The control module is configured to modify operation of the one or more defense systems. The one or more defense systems may include non-lethal weapons. The one or more defense systems may include a sound gun.

The security hood may include at least one battery. The security hood may include a proximity sensor operable to determine a distance of persons from the security hood.

An embodiment of a system for restricting access to an area includes a security barrier having a tower and a security hood. The security hood includes a control module, a plurality of lights positioned on a front of the security hood, a speaker operable to broadcast audible warnings, and a communications system. The control module is operable to change the security hood between an inactive state and an active state, and is configured to modify operation of the security hood. The communications system includes a communications link to permit transmissions to and from the security hood.

The communications link may be a link with a law enforcement agency. The communications link may be a link with a law enforcement vehicle and the control module may modify operation of the security hood due to its proximity to the law enforcement vehicle.

The system may include at least one secondary security barrier. The control module of the security barrier may include a central command module configured to control operation of the secondary security barriers.

An embodiment of a method of restricting access to an area includes establishing a communications link between a remote command location and a security hood of a security barrier. The security barrier restricts movement across the area. The security hood includes a plurality of lights and a speaker. The security hood is operable to switch between an active state and an inactive state. The method includes transmitting a command from the remote command location to the security hood to switch the security hood from the inactive state to the active state. Switching from the inactive state to the active state modifies operation of the plurality of lights and the speaker.

The command from the remote command location may be transmitted through a satellite link with the security hood. The method may include establishing a communications link between the security barrier and the secondary security barriers. The method may include transmitting a command from the security barrier to the secondary security barriers to modify operation of the secondary security barriers.

As used herein, a security barrier is a vehicle-impact rated barrier, which is designed to stop or at least considerably slow a vehicle upon impact. Security barriers are often found in areas, such as military bases or buildings, wherein unauthorized access by vehicle would comprise security or endanger persons in the area. Examples of security barriers include barriers that would be rated under U.S. Department of State SD-STD-02.01 standard, CWA 16221:2010, ASTM F2656-07, PAS 68:2013, or ISO IWA 14-1: 2013 for a desired application. For instance, the security barrier and security hood may be ASTM F2656-50M rated. By way of example, a security barrier positioned outside a military base may require a greater rating than a security barrier for a parking lot or a concert venue. Furthermore, it is appreciated that while these security barriers may restrict access to an area, it is often impractical to completely prevent access.

### BRIEF DESCRIPTION OF THE DRAWINGS

FIG. 1 shows an embodiment of a security barrier with a security hood;

FIG. 2 is a rear perspective view of an embodiment of a security hood for a security barrier;

FIG. 3 is a schematic view of a security hood for a security barrier; and

FIG. 4 is an illustration of security barriers with security hoods selectively restricting access to an area.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure as defined by the appended claims.

### DETAILED DESCRIPTION

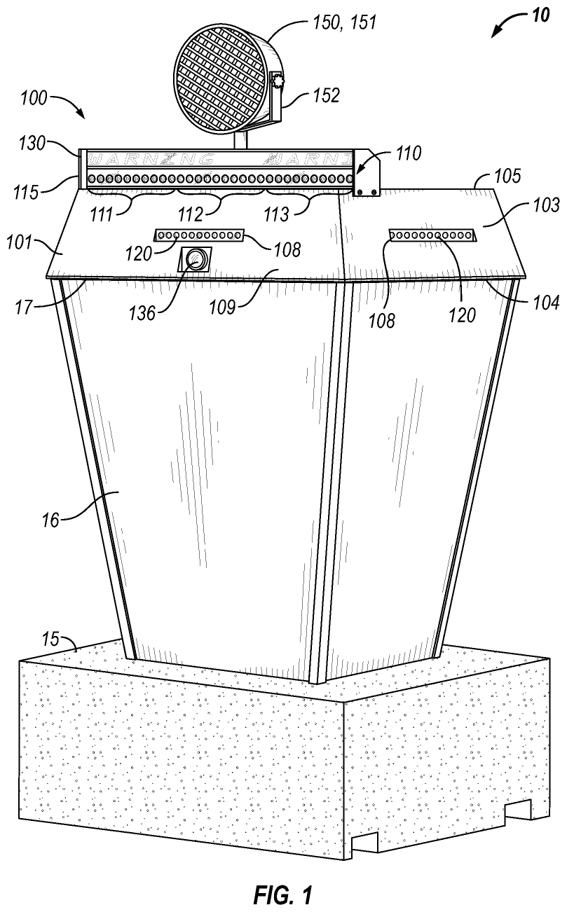

FIG. 1 shows an embodiment of a security barrier 10. The security barrier 10 includes a base 15 and a tower 16 extending upward from the base 15. In the following description, unless otherwise indicated, directional terms, such as above, below, up, down, etc. are with reference to the orientation of structure shown in the figures, and down is considered to be aligned with gravitational forces. For purposes of illustration, some dimensions may be exaggerated. The security barrier 10 includes a security hood 100. In some embodiments, the security hood 100 may be integrated directly with the tower 16 of the security barrier 10. In some embodiments, the security hood 100 may be shaped to be received upon the top 17 of the tower 16 of the security barrier 10. By way of example, the security hood 100 may be operable to be received upon the top of a security barrier as shown in U.S. Pat. No. 10,385,526 by Jacob Caval, titled Security Barrier and Methods, which is incorporated herein by reference in its entirety.

The top 17 of the tower 16 is shaped complementary to a bottom 104 of the security hood 100. For instance, the top 17 of the tower 16 of the security barrier 10 may have a top opening with a rectangular profile and the security hood 100 may include a bottom 104 that has a rectangular profile so that it may be received within the top opening.

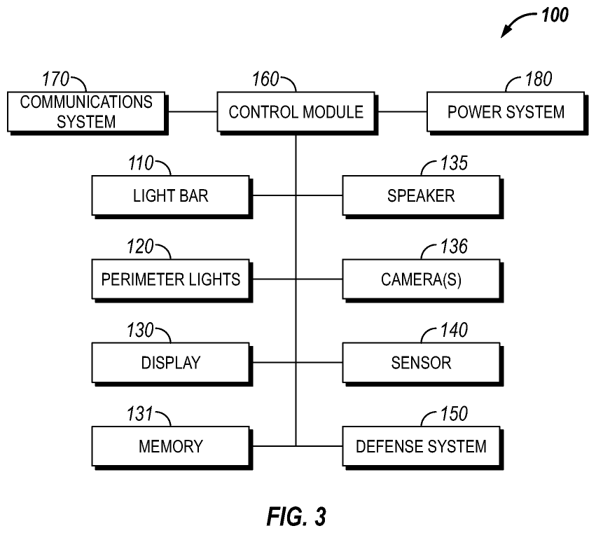

The security hood 100 includes a body 109 to protect and house electrical components of the security hood 100. The security hood 100 may include a communications system 170 and control module 160 (shown in FIG. 3) that is contained within the body 109. The body 109 includes a front 101, a bottom 104, and a top 105 opposite the bottom 104. The body 109 may include a plurality of sides 103, including the front 101. The plurality of sides 103 includes a rear side 102 opposite the front 101. The top 105 extends between the plurality of sides 103. The front 101 and/or the plurality of sides 103 may be sloped between the bottom 104 to the top 105. The front 101 and/or the plurality of sides 103 may be sloped from the bottom 104 to the top 105. The sloped surface may be advantageous to deflect projectiles that are forced into contact with the security hood 100. The body 109 of the security hood 100 may be formed of a suitable material for its application, such as aluminum, metal, wood, plastic, or fiberglass. For riot applications, it may be desirable to use, for example, 0.25 inch (6.35 mm) or thicker steel.

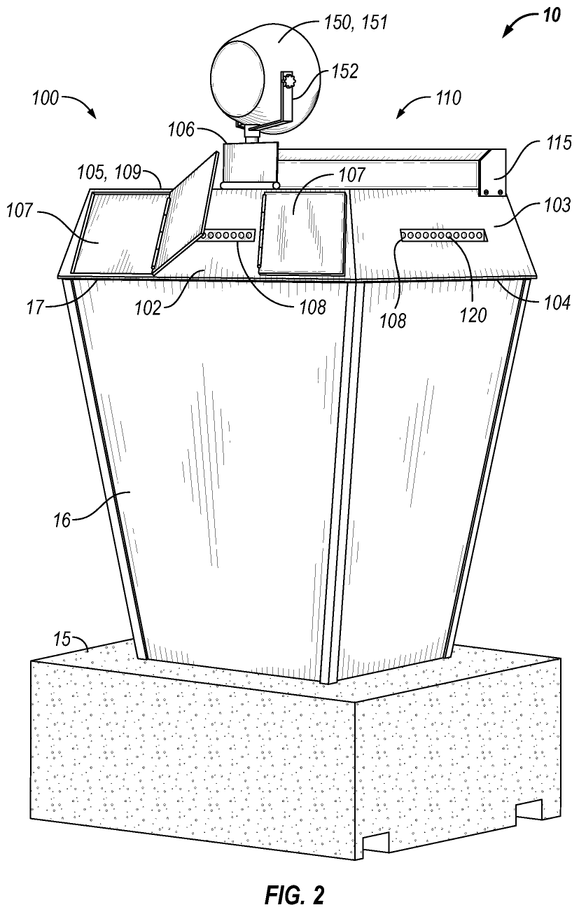

As shown in FIG. 2, the rear side 102 may include one or more rear hatches 107 for providing access into the security hood 100. The top 105 may include a top hatch 106 to provide access into the security hood 100. The top hatch 106 may provide access to an anchor on the tower 16 (shown in FIG. 1) in order to lift and move the security barrier 10. The top hatch 106 may also include a mount for connecting additional equipment, such as defense systems 150 (shown in FIG. 1) to the top 105 of the security hood 100. A plurality of openings 108 may be positioned on the body 109 of the security hood 100 to provide space for mounting audio and/or visual components. The openings 108 may be of a sufficient depth for the audio and/or visual components to be recessed so that they are mounted without extending beyond the outer surface of the body 109 of the security hood 100. Preferably, the audio and/or visual components may be recessed at least 0.125 inches (3.175 mm) from the outer surface of the body 109 of the security hood 100.

Referring again to FIG. 1, the security hood 100 includes one or more lights operable to flash in a predetermined pattern of colors, speeds, and/or combinations. The lights may include white, amber, red, blue, purple, or a combination thereof. Purple lights may be preferential to communicate warnings that are not typically associated with emergency services. For instance, purple lights are used in funeral processions and may be used on a security barrier 10 to communicate that lethal force may be used beyond the security barrier 10. The lights may be used to communicate directions and/or to disorient persons in the vicinity of the security barrier 10. The one or more lights include a light bar 110 and/or a plurality of perimeter lights 120 distributed around a perimeter of the security hood 100.

At least one of the perimeter lights 120 may be positioned on the front 101 and each of the plurality of sides 103. The perimeter lights 120 are operable to flash in a predetermined pattern of colors, speeds, and/or combinations. Each of the perimeter lights 120 may include at least two light colors. The perimeter lights 120 may be recessed within the body 109 of the security hood 100 to inhibit damages from projectiles, such as projectiles thrown by rioters. In some embodiments, the perimeter lights 120 may have a width of six inches or less. It may be advantageous to limit the surface area of the perimeter lights 120 to reduce a likelihood of contact with projectiles.

The security hood 100 may include a light bar 110. The light bar 110 may be oriented towards the front 101 of the security hood 100. The light bar 110 may extend along the top 105 of the security hood 100. In some embodiments, the light bar 110 may be recessed into the front 101 of the security hood 100. A guard 115 may partially enclose the light bar 110 and/or display 130 to prevent projectiles from damaging the light bar 110 and/or display 130. For instance, the guard 115 may cover the top of the light bar 110 such that a projectile, such as a Molotov cocktail, that lands upon the top 105 of the security hood 100 does not damage the light bar 110. The guard 115 may be formed of steel having a thickness of at least 0.25 inches (6.35 mm). The guard 115 may also slope away from the front 101 and towards the rear side 102 of the security hood 100, as best shown in FIG. 2.

The light bar 110 may include a plurality of sections that may be illuminated independently of each other. For instance, the light bar 110 may include a first section 111, a second section 112, and a third section 113. The second section 112 is positioned linearly between the first section 111 and the third section 113. Each of the plurality of sections 111, 112, 113 may be formed of a plurality of lights, such as light-emitting diodes.

The security hood 100 may include a display 130 to broadcast written messages. The display 130 may be positioned on the front 101 of the security hood. In some embodiments, the display 130 is positioned above the light bar 110. The display 130 may be a scrolling display. The display 130 may have a height of 2 inches (50.8 mm) or less. It may be advantageous to limit the surface area of the display 130 to reduce a likelihood of contact with projectiles. For example, the display 130 may include a message “DO NOT ENTER” or another message to be communicated.

The security hood 100 may include one or more speakers 135 operable to broadcast audible warnings to the area surrounding the security barrier 10. The speakers 135 may include a horn. The speakers 135 may include prerecorded verbal messages or sounds.

The security hood 100 may include one or more cameras 136. A camera 136 is positioned on the front 101 of the security hood 100. The camera 136 may be operable to take single images or a video stream of images. The cameras 136 may be recessed within the front 101 of the security hood 100. A plurality of cameras 136 may be positioned on the security hood to provide a 360-degree field of view. In some embodiments, the cameras 136 are biometric cameras that provide information to a law enforcement agency. The biometric cameras may receive biometric information from a law enforcement agency for comparison with persons within the vicinity of the security barrier 10. The cameras 136 may have a lens diameter of less than 10 millimeters and preferably less than 6 millimeters. It may be advantageous to use cameras having a small lens diameter to reduce the likelihood of impact of projectiles on the cameras. For instance, a 9-millimeter caliber projectile would be larger than a 6-millimeter opening containing a camera lens and could only be slightly misaligned with a 10-millimeter opening to reach a camera lens within that opening.

FIG. 3 is a schematic view of the security hood 100 for the security barrier 10. The security hood 100 is operable to receive instructions from a remote command location and implement the instructions to alter operation of the security hood 100. The security hood 100 includes a light bar 110, perimeter lights 120, a display 130, and one or more speakers 135 for conveying audio and/or visual information to persons in the vicinity of the security barrier 10. The security hood 100 also includes one or more cameras 136 and/or sensors 140 for collecting data to be relayed to the remote command location. The one or more cameras 136 and/or sensors 140 may also collect data that can be used to control operation of the security hood 100. By way of example, the sensors 140 may include a microphone. The sensors 140 may include a proximity sensor to determine the distance of persons from the security barrier 10.

The security hood 100 includes memory 131, a control module 160, a communications system 170, and a power system 180. The power system 180 includes a power source such as a grid-power connection, batteries, and/or a solar panel. Batteries may be desirable to be incorporated into the security barrier 10 to minimize the effect of unreliable power or solar energy that may occur during riots.

The memory 131 includes stored settings, prerecorded written messages, and prerecorded verbal messages. The memory 131 may also be used to store new settings, written messages, and prerecorded verbal messages received from a remote command location. The control module 160 is operated to modify the functions of the light bar 110, perimeter lights 120, display 130, one or more speakers 135, and one or more cameras 136. In some embodiments, the control module 160 includes a central command module that controls operation of secondary security barriers 10 with security hoods 100 in the surrounding area. This may be advantageous to minimize the number of communication links needed to be established with the remote command location. Commands may be received from the remote command location to a security hood 100 and the central command module of the control module 160 may replicate these commands to other security hoods 100.

The communications system 170 is configured for bi-directional communication between the control module 160 and a remote command location. The communications system 170 provides data received from the remote location to the control module 160 and the control module 160 implements changes to the operation of security hood 100. The communications system 170 may also relay data collected by the security hood 100, such as camera images, to the remote location. The communications system 170 includes a communications link, such as a satellite link or a cellular connection, to permit transmissions to and/or from the security hood 100. For instance, the security hood 100 may be in communication with a central command module, another security hood 100, a governmental agency, and/or to a security agency. In some embodiments, the security hood 100 may be controlled through the use of an application on a phone or computer, such as a secure law enforcement terminal.

The security hood 100 may include one or more defense systems 150, such as nonlethal weapons. The defense systems 150 are operable to cause discomfort to unauthorized persons in the vicinity. In some applications, the defense systems may include the use of lethal force. The nonlethal weapons may include an electroshock weapon, a chemical spray, and/or a sound gun 151. As shown in FIG. 1, the security hood 100 may include a sound gun 151 extending beyond the body 109 of the security hood 100. The sound gun 151 uses acoustics to injure or incapacitate a person. The sound gun 151 includes a swivel 152 that permits the sound gun 151 to pivot up to 180 degrees but prevents the sound gun 151 from being pointed to the rear side 102 of the security hood 100.

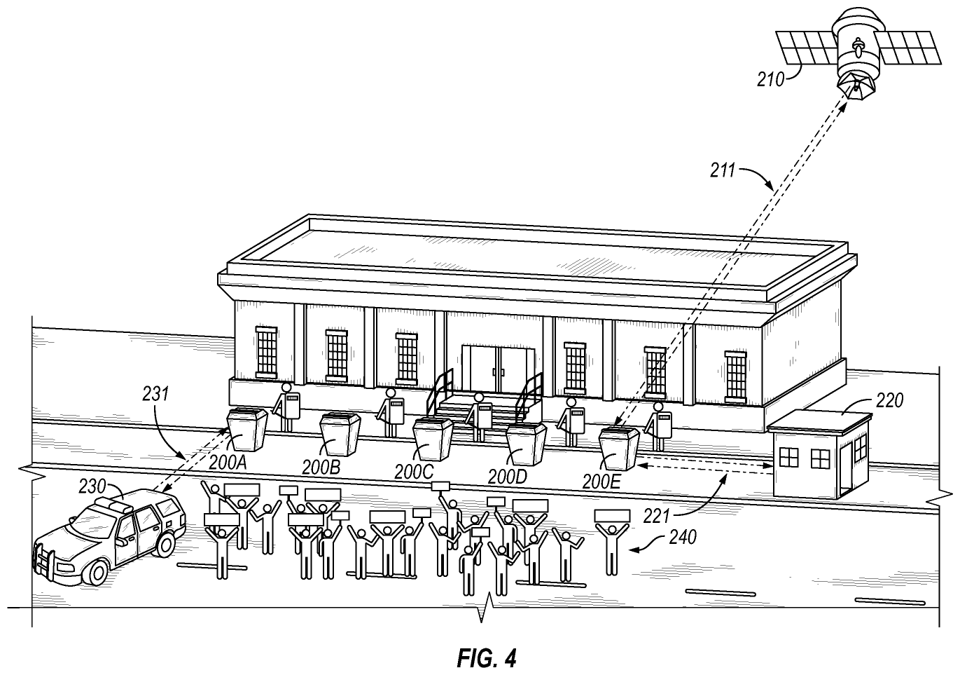

FIG. 4 is an illustration of a plurality of security barriers 200A, 200B, 200C, 200D, 200E (collectively referred to as security barriers 200) with security hoods selectively restricting access to an area. One or more of the security barriers 200 may include a central command module for controlling operation of the other security barriers 200 (secondary security barriers) in the area. A communications link may be established between multiple security barriers 200 and a command transmission may be transmitted between the security barriers 200 to be operated collectively. In some embodiments, the security barrier 200 may be activated, or its operation altered, due to the proximity of the security barrier 200 to a command transmission. For instance, a law enforcement vehicle 230 may establish a vehicle link 231 with a security barrier 200. The vehicle link 231 may be used to carry a command transmission from the law enforcement vehicle 230 to the security barrier 200 to alter operation of the security barriers 200. In some embodiments, a satellite 210 may establish a satellite link 211 with a security barrier 200. The satellite link 211 may be used to carry a command transmission from the satellite 210 to the security barrier 200 to alter operation of the security barriers 200. A governmental agency and/or to a security agency may establish a link 221 with a security barrier 200. The link 221 may be used to carry a command transmission from an operation center, such as a security booth 220 or law enforcement agency, to the security barrier 200 to alter operation of the security barriers 200. As used herein, a remote location includes a law enforcement vehicle 230 and locations connected by a satellite link 211 or other link 221, such as a government agency.

An operator may selectively restrict access by persons 240 to an area behind the security barriers 200 by activating one or more of the security barriers 200. Initially, the security barriers 200 may be placed in an inactive state, allowing persons 240 to pass between the security barriers 200. In the inactive state, video may still be transmitted from the camera(s) 136 (shown in FIG. 1) of the security barriers 200 to a remote command location. However, in the event that the operator desires to restrict access by the persons 240, the security barriers 200 may be switched to an active state. In the active state, one or more of the audio and/or visual components may be activated to warn the persons 240 that their access is no longer authorized. This may include flashing the light bar 110 and/or perimeter lights 120 in a predetermined pattern of colors, speeds, and/or combinations; presenting written dialog on the display 130; and/or playing verbal messages or sounds through the speaker(s) 135. In some embodiments, the control module 160 may be operable to engage perimeter lights 120 before activating the speakers 135. The operator may activate defense systems 150, such as a sound gun 151, to inhibit further access into the area. In some embodiments, the defense systems 150 may activate automatically when unauthorized persons 240 come within a predetermined distance of the security barriers 200 while they are in the active state, as determined by a proximity sensor or cameras.

By way of example, a security barrier 200 having a security hood 100 (shown in FIG. 1) may instruct persons in the area to move to the right by sequentially illuminating first section 111, then second section 112, and then third section 113 of light bar 110. The sequential illumination may be continued across adjacent security barriers 200. The display 130 may display a message, such as “Turn Left”, while the light bar 110 is illuminated and/or the speakers 135 may broadcast a prerecorded message.

To inhibit access to the area, the light bar 110 and/or perimeter lights 120 may flash and the frequency of the flashing may increase as the unauthorized persons approach the security barrier 200. The light bar 110 and perimeter lights 120 may alternate illuminating. The light bar 110 and/or perimeter lights 120 may change colors as the unauthorized persons approach the security barrier 200.

Although this disclosure has been described in terms of certain embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. A system for restricting access to an area, the system comprising:
a security hood including:
a body having a plurality of openings;
a plurality of lights positioned within the plurality of openings;
a control module operable to change the security hood between an inactive state and an active state, the control module operable to control the plurality of lights; and
a communications system operable to receive data from a remote command location and provide the data to the control module, the data including instructions for altering operation of the security hood.

2. The system of claim 1, wherein the security hood has a bottom shaped complementary to a top of a tower of a security barrier, the security hood is configured to attach to the tower.

3. The system of claim 1, further comprising a security barrier having a tower, wherein the security hood is integral to the tower of the security barrier.

4. The system of claim 1, wherein the body including a plurality of sides, the plurality of sides includes a front, at least one of the plurality of openings is positioned on the front.

5. The system of claim 4, wherein at least one of the plurality of lights is recessed within the at least one opening on the front.

6. The system of claim 4, wherein the body include a top extending between the plurality of sides, and the front is sloped towards the top.

7. The system of claim 4, wherein the security hood includes a light bar oriented towards the front, the light bar having a plurality of sections that can be illuminated independently of each other, the control module configured to modify operation of the light bar.

8. The system of claim 7, further comprising a guard partially enclosing the light bar and covering a top of the light bar.

9. The system of claim 7, further comprising a speaker operable to broadcast audible warnings, the control module configured to modify operation of the speaker.

10. The system of claim 4, further comprising a display positioned on the front of the security hood, the display operable to broadcast written messages, the control module configured to modify operation of the display.

11. The system of claim 4, further comprising a camera and wherein the communications system is operable to transmit images taken by the camera to the remote command location.

12. The system of claim 4, further comprising one or more defense systems, the control module configured to modify operation of the one or more defense systems.

13. The system of claim 4, wherein the security hood includes a proximity sensor, the proximity sensor operable to determine a distance of persons from the security hood.

14. The system of claim 1, wherein the security hood includes at least one battery.

15. The system of claim 1, wherein the communications system includes a satellite link.

16. A system for restricting access to an area, the system comprising:
a security barrier having a tower and a security hood, the security hood including:
a control module operable to change the security hood between an inactive state and an active state, the control module operable to control the security hood;
a plurality of lights positioned on a front of the security hood;
a speaker operable to broadcast audible warnings; and
a communications system with a communications link to permit transmissions to and from the security hood.

17. The system of claim 16, wherein the communications link is a link with a law enforcement agency.

18. The system of claim 16, wherein the communications link is a link with a law enforcement vehicle and the control module is configured to modify operation of the security hood due to its proximity to the law enforcement vehicle.

19. The system of claim 16, further comprising a secondary security barrier, wherein the control module of the security barrier includes a central command module configured to control operation of the secondary security barrier.

20. A method of restricting access to an area, the method comprising:
establishing a communications link between a remote command location and a security hood of a security barrier, the security barrier restricting movement across the area, the security hood including a plurality of lights and a speaker, wherein the security hood is operable to switch between an active state and an inactive state; and
transmitting a command from the remote command location to the security hood to switch the security hood from the inactive state to the active state, wherein switching from the inactive state to the active state modifies operation of the plurality of lights and the speaker.

21. The method of claim 20, wherein the command from the remote command location is transmitted through a satellite link to the security hood.

22. The method of claim 20, further comprising:
establishing a communications link between the security barrier and a secondary security barrier; and
transmitting a command from the security barrier to the secondary security barrier to modify operation of the secondary security barrier.
